(19) United States
(12) Patent Application Publication
(10) Pub. No.: US 2006/0021282 A1
(43) Pub. Date: Feb. 2, 2006

(54) Glass run

(75) Inventors: Kiyotaka Tamaoki, Aichi-ken (JP); Takeshi Ishikawa, Wako-shi (JP); Jiro Yamaguchi, Wako-shi (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD, Aichi-ken (JP); KABUSHIKI KAISHA HONDA MOTOR CO., LTD., Tokyo (JP)

(21) Appl. No.: 11/194,734

(22) Filed: Aug. 2, 2005

(30) Foreign Application Priority Data
Aug. 2, 2004 (JP) 2004-225544

(51) Int. Cl. E06B 7/16

(52) U.S. Cl. 49/441

(57) ABSTRACT

A glass run is assembled to an automobile door having a door glass. The glass run includes a first base portion adapted to be fitted in a sash, a facing wall part provided so as to substantially face an exterior side surface of a guide member, the exterior wall part provided substantially in parallel with an exterior side surface of the guide member, an exterior seal lip which seals the exterior side surface of the guide member, a restricting wall part which restricts a projecting portion, a mount wall part adapted to be mounted on an interior member, an interior seal lip which seals an interior side of the guide rail, an exterior sub-seal lip and an interior sub-seal lip which are provided between the exterior seal lip and the interior seal lip.

### BACKGROUND OF THE INVENTION

1. Field of the Invention

The present invention relates to a glass run mounted on a vehicle door.

2. Related Art

Generally, a glass run for sealing a peripheral portion of a door glass, which moves, is provided on a door of a vehicle such as an automobile. The glass run has a main body with a substantially U-shaped cross section and a pair of seal lips which extend substantially from distal ends of both side walls of the main body toward an inside of the main body. The main body is brought into engagement with a sash which is provided on the door. Then, an interior side surface and an exterior side surface of the door glass are sealed by means of the pair of seal lips along the peripheral portion of the door glass.

In addition, in recent years, in order to suppress the generation of wind noise while a vehicle is running fast and to improve the quality of external appearance, there has been a demand for a technique for making an exterior surface of a door flush with an exterior surface of a door glass (a flush surface).

In view of the demand, there has been proposed a technique in which a flush surface is realized by providing a guide member along a vertical side portion of a door glass and sealing an interior side surface and an exterior side surface of the guide member with a pair of seal lips (for example, refer to FIGS. 4, 5 of Japanese Utility model Publication No. JP S62-4415U).

However, since the moving position of the door glass varies when the door glass is pushed inward by air pressure or the like, there has been caused a risk that the sealing performance is reduced in the event that the sealing is effected only with the interior and exterior seal lips.

### SUMMARY OF THE INVENTION

The invention was made with a view to solving the problem, and an object thereof is to provide a glass run which can realize not only a flush surface between the door and the door glass but also a further improvement in sealing property.

Hereinafter, aspects of the invention which are suitable for attaining the object will be itemized for description below.

(1) A glass run adapted to be mounted on a vehicle door having a door glass adapted to move up and down and a guide member provided along a vertical part of the door glass such that an edge portion thereof protrudes from an end face of the vertical part of the door glass, the glass run including:

a main body adapted to be mounted on a mount portion of the vehicle door;

a first seal lip continuously formed with the main body so as to be brought into contact with an exterior side surface of the guide member for forming a seal thereat;

a second seal lip continuously formed with the main body so as to be brought into contact with the door glass or an interior side surface of the guide member for forming a seal thereat; and

a third seal lip and a fourth seal lip which are continuously formed with the main body between a portion where the first seal lip is continuously formed with the main body and a portion where the second seal lip is continuously formed with the main body, the third seal lip being adapted to be brought into contact with the guide member at a position inward of the first seal lip for forming a seal thereat and the fourth seal lip being adapted to be brought into contact with the guide member at a position inward of the third seal lip for forming a seal thereat.

By providing the third seal lip and the fourth seal lip between the first seal lip which is located in the exterior side and the second seal lip which is located in the interior side, the improvement in sealing property can be realized. In addition, according to this aspect of the invention, since two seal lips, that is, the third and fourth seal lips are provided between the first and second seal lips, when compared with a configuration in which only one seal lip is provided as a third seal lip therebetween, the sealing performance is increased remarkably. Furthermore, in case the position of the door glass is caused to deviate for some reason, depending upon the direction in which the position deviates, with only the single third seal lip, there is caused a risk that the sealing property is reduced. However, according to the above aspect of the invention, such a risk can be reduced. As a result, the vehicle door and the door glass can be made flush with each other (the flush surface can be realized therebetween) and a further improvement in sealing property can be realized.

(2) A glass run adapted to be mounted on a vehicle door having a door glass adapted to move up and down and a guide member provided along a vertical part of the door glass such that an edge portion thereof protrudes from an end face of the vertical part of the door glass, the glass run including:

a main body including, in turn, a first base portion adapted to be mounted on a first mount section of the vehicle door which is provided substantially in parallel with an interior side surface of the door glass, a second base portion adapted to be mounted on a second mount section of the vehicle door which extends from one end portion of the first base portion and which is provided so as to substantially face an end face of the vertical part of the door glass and an end face of the edge portion of the guide member, and a third base portion adapted to be mounted on a third mount section of the vehicle door which extends from the other end portion of the first base portion and which is provided in the vicinity of the first mount section;

a first seal lip extending substantially from a distal end portion of the second base portion so as to be brought into contact with an exterior side surface of the guide member for forming a seal thereat;

a second seal lip extending substantially from a distal end portion of the third base portion so as to be brought into contact with an interior side surface of the guide member for forming a seal thereat;

a third seal lip extending from the second base portion so as to be brought into contact with the guide member at a position inward of the first seal lip for forming a seal thereat; and

a fourth seal lip extending from the first base portion or the second base portion so as to be brought into contact with the guide member at a position inward of the third seal lip for forming a seal thereat.

Even in the event that the moving position of the door glass is caused to deviate inward or toward the second base portion side, the layout of the third and fourth seal lips according to this aspect of the invention can restrict such a movement of the door glass so that the door glass can maintain the proper moving position thereof. As a result, the realization of the flush surface can be attained in a more ensured fashion, and the reduction in sealing property can be suppressed.

(3) A glass run adapted to be mounted on a vehicle door having:

a door glass adapted to move up and down; and

a guide member provided along a vertical part of the door glass such that an edge portion thereof protrudes from an end face of the vertical part of the door glass and having a projecting portion which is projected inward on an interior side surface of the edge portion and the vicinity thereof, the glass run including:

a main body including, in turn, a first base portion adapted to be mounted on a first mount section of the vehicle door which is provided substantially in parallel with an interior side surface of the door glass, a second base portion adapted to be mounted on a second mount section of the vehicle door which extends from an end portion of the first base portion and which is provided so as to substantially face an end face of the vertical part of the door glass and an end face of the edge portion of the guide member, and a third base portion adapted to be mounted on a third mount section of the vehicle door which extends from the other end portion of the first base portion and which is provided in the vicinity of the first mount section;

a first seal lip extending substantially from a distal end portion of the second base portion so as to be brought into contact with an exterior side surface of the guide member for forming a seal thereat;

a second seal lip extending substantially from a distal end portion of the third base portion so as to be brought into contact with an interior side surface of the guide member for forming a seal thereat;

a third seal lip extending from the second base portion so as to be brought into contact with the guide member at a position inward of the first seal lip for forming a seal thereat; and

a fourth seal lip extending from the first base portion or the second base portion so as to be brought into contact with the guide member at a position inward of the third seal lip for forming a seal thereat.

By providing the guide member having the projecting portion, a sealing surface that is sealed by the seal lips is increased, thereby making it possible to realize a further improvement in sealing property.

(4) The third base portion may include:

a restricting wall part which extends outward from the other end portion of the first base portion for restricting the projecting portion; and

a mount wall part which extends from a distal end portion of the restricting wall part so as to be mounted on the third mount section; and wherein

the second seal lip extends from a distal end portion of the mount wall part or the vicinity thereof.

By providing the restricting wall part, since a state results in which the edge portion (the projecting portion) of the guide member is surrounded by the restricting wall part, the first base portion, the first seal lip and the third and fourth seal lips, the deviation in position of the guide member and, hence, the door glass can be suppressed, so that the door glass is allowed to be maintained at the proper moving position thereof. As a result, the realization of the flush surface can be attained in a more ensured fashion, and the reduction in sealing property can be suppressed.

(5) The guide member may have a curved end face which curves from the edge portion of the guide member to an interior end portion of the projecting portion; and

the third seal lip and the fourth seal lip may be made to contact with the curved end face.

Since the third and fourth seal lips are made to be brought into contact with the curved end face, even in the event that the position of the door glass is caused to deviate in a transverse direction, the sealing amount of both the third and fourth seal lips is easy to be secured, thereby making it possible to suppress the reduction in sealing property.

(6) The guide member may be provided such that the exterior side surface thereof becomes substantially in parallel with the interior side surface of the door glass and that a transverse position of the exterior side surface of the guide member is located at the same position as or inward of the interior side surface of the door glass;

the second base portion may comprise a facing wall part which extends from the end portion of the first base portion and which is provided so as to substantially face the end face of the vertical part of the door glass and the end face of the edge portion of the guide member, and

an exterior wall part which extends from a distal end of the facing wall part toward the end face of the door glass and which is provided substantially in parallel with the exterior side surface of the guide member; and

the first seal lip may be made to extend from a distal end portion of the exterior wall part toward the facing wall part.

Since the exterior side surface of the guide member is made to be located at the same position as or inward of the interior side surface of the door glass and the first seal lip is made to contact with the exterior side surface of the guide member, the flush surface can be realized in a more ensured fashion.

(7) The guide member may be provided such that the whole of the guide member is positioned inward of the interior side surface of the door glass.

When compared with a type of guide member which is mounted so as to hold the vertical part of the door glass from the interior and exterior sides thereof, the flush surface can be realized to a greater extent.

(8) The third seal lip and the fourth seal lip may be made to be brought into elastic contact or press contact with the guide member, respectively.

When compared with a configuration in which the seal lips are made to contact with a portion which is relatively poor in elasticity (hard portion) such as part of the main body or are brought into contact with such a portion due to the deviation in position of the door glass, a drawback can be suppressed that the moving of the door glass is interrupted. Furthermore, by bringing the third and fourth seal lips into elastic contact with the guide member, the door glass is allowed to be maintained at the proper moving position thereof. As a result, the flush surface can be attained to a greater extent and a further improvement in sealing property can be realized.

(9) The third seal lip and the fourth seal lip may be formed so as to protrude toward each other.

The third seal lip protrudes toward the fourth seal lip, and the fourth seal lip protrudes toward the third seal lip. Consequently, the deviation in position of the door glass can be restricted in a more ensured fashion by supporting a corner portion formed by the edge portion and an interior side wall portion of the guide member and the curved end face, which is formed along the edge portion of the guide member as has been described above between the third and fourth seal lips. As a result, the flush surface can be attained to a greater extent and a further improvement in sealing property can be realized.

(10) The third seal lip and the fourth seal lip may constitute a pair of seal lips whose cross-sectional shapes become substantially symmetrical.

The third and fourth seal lips are made to be brought into contact with the guide member with a more uniform force, thereby making it possible to stabilize the moving position of the door glass further. As a result, the flush surface can be attained to a greater extent and a further improvement in sealing property can be realized.

(11) A vehicle door comprising:

a door glass;

a guide member attached on an interior side surface of the door glass in a vertical part of the door glass such that an edge portion of the guide member protrudes from an end face of the vertical part of the door glass and an exterior side surface of the guide member is located on an interior side with respect to an exterior side surface of the door glass,

a glass run to guide the door glass, including
a main body engaged with a mount portion,
a first seal lip continuously formed with the main body so as to be brought into contact with the exterior side surface of the guide member,
a second seal lip continuously formed with the main body so as to be brought into contact with one of the interior side surface formed in the door glass or the guide member, and
a third seal lip and a fourth seal lip which are continuously formed with the main body between a position at which the first seal lip is formed and a position at which the second seal lip is formed, the third seal lip being brought into contact with an end face of the guide member and the fourth seal lip being brought into contact with a curved face of the guide member formed on an interior side of the end face.

### BRIEF DESCRIPTION OF THE DRAWINGS

FIG. 1 is a front view of a door to which a glass run is assembled; and

FIG. 2 is a partial cross-sectional view taken along the line II-II in FIG. 1, which explains the glass run and a door sealing construction.

### DETAILED DESCRIPTION OF THE PREFERRED EMBODIMENTS

An embodiment of the invention will be described by reference to the drawings.

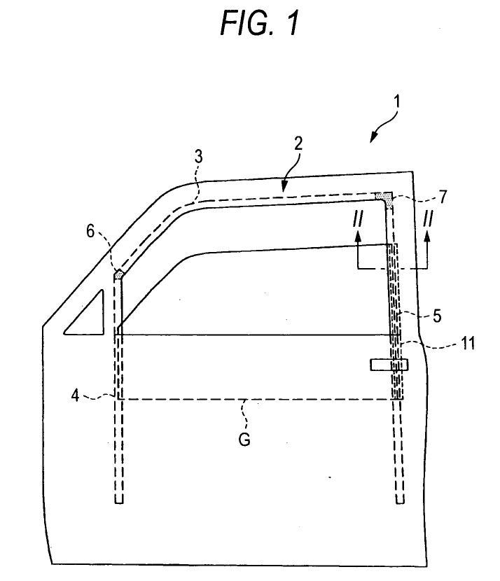

As shown in FIG. 1, an automotive door (a front door in the figure: hereinafter, simply referred to as a door), which functions as a vehicle door provided at an opening in an automobile body as a vehicle main body so as to be opened and closed, includes a door glass G which is adapted to move up and down and a glass run 2 made from EPDM (ethylene-propylene-diene terpolymer) which corresponds to an outer peripheral shape of the door glass G.

As viewed in a longitudinal direction thereof, the glass run 2 is provided with an extruded portion 3 which corresponds to an upper member portion of the glass run 2, extruded portions 4, 5 which correspond, respectively, to front and rear vertical portions of the glass run 2 and molded portions 6, 7 (portions given to a dotted pattern in the figure) which connect end portions of the respective extruded portions 3, 4, 5 to each other. The respective extruded portions 3 to 5 are formed substantially linearly by an extruding machine, not shown. In addition, the molded portions 6, 7 are molded to be connected, respectively, to the two extruded portions 3, 4 and another two extruded portions 3, 5 in such a state that the respective two extruded portions are connected via the molded portions 6, 7 so as to form predetermined angles therebetween by a molding apparatus, not shown.

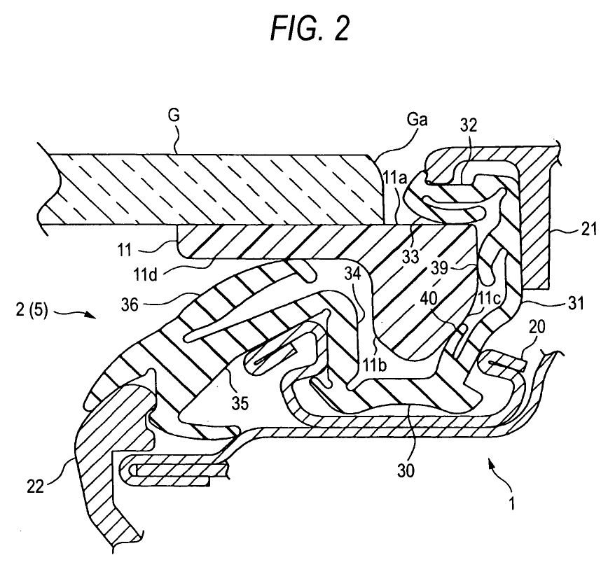

Next, referring to FIG. 2, which is a partial cross-sectional view taken along the line II-II in FIG. 1, a sealing construction at a rear vertical portion of the door will be described in detail based on the configuration of the door glass G, the configuration of the vertical portion (the extruded portion) 5 of the glass run 2 and the configuration of a mount portion of the door 1 on which the glass run 2 is mounted. Note that since a sealing construction at the front vertical portion of the door 1 is similar to the sealing construction at the rear vertical portion, the detailed description thereof and illustration of a guide rail 11, which will be described later on, will be omitted herein.

A guide rail 11, which functions as a guide member, is provided at a vertical part so as to extend along the vertical part of the door glass G. The guide rail 11 is made from PBT (polybutylene terephthalate) and is securely attached to an interior side surface of the door glass G with an adhesive. An edge portion of the guide rail 11 protrudes outward from an end face Ga of the vertical part of the door glass G and has an exterior side surface 11a which is substantially in parallel with the interior side surface of the door glass G on an exterior side surface thereof and a projecting portion 11b which is projected inward on an interior side surface thereof. Then, a transverse position of the exterior side surface 11a of the guide rail 11 is located substantially at the same position as the interior side surface of the door glass G, and the whole of the guide rail 11 is located inward of the interior side surface of the door glass G. In addition, the guide rail 11 has a curved end face 11c which curves from the edge portion of the guide rail 11 toward an interior end portion of the projecting portion 11b.

Next, the configuration of the mount portion of the door 1 on which the glass run 2 is mounted will be described. The door 1 includes a sash 20, functioning as a first mount section, which is provided substantially in parallel with the interior side surface of the door glass G, an exterior member (a retainer) 21, functioning as a second mount section, which is provided so as to substantially face the end face Ga of the vertical part of the door glass G and an end face (part of the curved end face 11c) of the edge portion of the guide rail 11, and an interior member 22, functioning as a third mount section, which is provided in the vicinity of the sash 20. Note that an exterior side surface of the exterior member 21 is substantially flush with an exterior side surface of the door glass G.

Following this, the configuration of the vertical portion 5 of the glass run 2 will be described. The vertical portion 5 of the glass run 2 includes a first base portion 30 which is adapted to be fitted in the sash 20, a facing wall part 31 which extends from an one end portion of the first base portion 30 and which is provided so as to substantially face the end face Ga of the vertical part of the door glass G and the curved end face 11c of the guide rail 11, an exterior wall part 32 which extends from a distal end of the facing wall part 31 toward the end face Ga of the door glass G, which is provided substantially in parallel with the exterior side surface 11a of the guide rail 11 and which is adapted to be mounted on the exterior member 21 when a distal end portion thereof is locked on the exterior member 21, an exterior seal lip 33, functioning as a first seal lip, which extends from a distal end portion of the exterior wall part 32 toward the facing wall part 31 so as to be brought into contact with the exterior side surface 11a of the guide rail 11 for forming a seal thereat, a restricting wall part 34 which extends outward from the other end portion of the first base portion 30 so as to restrict the projecting portion 11b, a mount wall part 35 which extends from a distal end portion of the restricting wall part 34 and which is adapted to be mounted on the interior member 22 when a distal end portion thereof is locked on the interior member 22, an interior seal lip 36, functioning as a second seal lip, which extends outward from the vicinity of a distal end portion of the mount wall part 35 so as to be brought into contact with an interior side surface 11d of the guide rail 11 for forming a seal thereat and a pair of seal lips (an exterior sub-seal lip 39 and an interior sub-seal lip 40) which are provided between the exterior seal lip 33 and the interior seal lip 36. The exterior sub-seal lip 39 constitutes a third seal lip of the embodiment, and the interior sub-seal lip 40 constitutes a fourth seal lip thereof. In addition, a second base portion of the embodiment is provided with the facing wall part 31 and the exterior wall part 32, and a third base portion is provided with the restricting wall part 34 and the mount wall part 35. Additionally, a main body of the embodiment is provided with the first base portion 30, the facing wall part 31, the exterior wall part 32, the restricting wall part 34 and the mount wall part 35.

Here, the pair of seal lips (the exterior sub-seal lip 39 and the interior sub-seal lip 40) will be described in detail. The exterior sub-seal lip 39 and the interior sub-seal lip 40 are formed so as to protrude toward each other. The exterior sub-seal lip 39 extends from a portion on the facing wall part 31 which substantially faces the end face (part of the curved end face 11c) of the edge portion of the guide rail 11 toward the first base portion 30 (inward) so as to be brought into elastic contact with the end face (part of the curved end face 11c) of the edge portion of the guide rail 11 at a position inward of the exterior seal lip 33 for forming a seal thereat. The interior sub-seal lip 40 extends from the vicinity of a portion where the first base portion is continuously formed with the facing wall part 31 toward the exterior wall part 32 (outward) so as to be brought into elastic contact with the curved end face 11c of the projecting portion 11b of the guide rail 11 at a position inward of the exterior sub-seal lip 39 for forming a seal thereat. Then, the curved end face 11c of the projecting portion 11b of the guide rail 11 is received and supported between the pair of seal lips 39, 40, so that the deviation in position of the door glass G is restricted.

Thus, as has been described heretofore, by providing the pair of sub-seal lips (the exterior sub-seal lip 39 and the interior sub-seal lip 40) between the exterior seal lip 33 and the interior seal lip 36, the improvement in sealing property can be attained. In addition, according to the embodiment, since the two sub-seal lips, that is, the pair of seal lips 39, 40 are provided as a third seal lip between the exterior seal lip 33 and the interior seal lip 36, when compared with the configuration in which only one seal lip is provided as a third seal lip therebetween, the sealing performance is increased remarkably. Furthermore, in case the position of the door glass is caused to deviate for some reason, depending upon the direction in which the position deviates, with only the single third seal lip, there is caused a risk that the sealing property is reduced. However, according to the embodiment, such a risk can be reduced. As a result, the door 1 and the door glass G can be made flush with each other (the flush surface can be realized therebetween) and a further improvement in sealing property can be realized.

In addition, since the curved end face 11c of the projecting portion 11b of the guide rail is received and supported between the pair of seal lips 39, 49 so as to restrict the deviation in position of the door glass G, the door glass G is allowed to be maintained at the proper moving position thereof, and even in the event that the position of the door glass G is caused to deviated in a transverse direction, the sealing amount of both the pair of seal lips 39, 40 is easy to be secured, thereby making it possible to suppress the reduction in sealing property. Furthermore, when compared with a configuration in which the seal lips are made to contact with a relatively hard portion such as the facing wall part 31 or are brought into contact with such a portion due to the deviation in position of the door glass, a drawback can be suppressed that the moving of the door glass G is interrupted.

Additionally, by adopting the guide rail 11 including the projecting portion 11b (the curved end face 11c) , the sealed surface that is sealed by the seal lips is increased, thereby making it possible to realize a further improvement in sealing property.

In addition, since a state results from providing the restricting wall part 34 in which the edge portion (the projecting portion 11b) of the guide rail 11 is surrounded by the restricting wall part, the first base portion 30, the exterior seal lip 33 and the pair of the seal lips 39, 40, the deviation in position of the guide rail 11 and, hence, the door glass G can be suppressed, whereby the door glass G is allowed to be maintained at the proper moving position thereof in a more ensured fashion.

Note that the invention is not limited to what has been described with respect to the embodiment but may be embodied as follows. It goes without saying that other application and modification examples than those that will be described below are, of course, acceptable.

(a) While, in the embodiment, the glass run 2 is described as being applied to the sealing construction of the front door 1, there is no limitation on the location of the door to which the sealing construction and the glass run 2, which have been described above, are applied, and therefore, the invention can be applied to, for example, a rear door.

(b) The configuration and material of the guide rail, which functions as the guide member, are not limited to the configuration and material of the guide rail 11 according to the embodiment. For example, a configuration may be adopted in which the projecting portion 11b is omitted. In this case, the guide rail is constructed such that the interior side surface and exterior side surface thereof are made substantially in parallel with each other, the exterior sub-seal lip 39 is made to be brought into contact with the end face of the edge portion of the guide rail, and the interior sub-seal lip 40 is made to be brought into contact with the interior side surface of the guide rail. In addition, a configuration may be adopted in which the guide rail is formed integrally with the door glass G. The guide rail may be of a type which holds the vertical part of the door glass G from the interior and exterior sides thereof.

(c) While, in the embodiment, the interior seal lip 36 is made to be brought into contact with the interior side surface lid of the guide rail 11, the interior seal lip 36 may be made to be brought into contact with the interior side surface of the door glass G.

(d) The configurations of the exterior sub-seal lip 39 and the interior sub-seal lip 40 are not limited to those described in the embodiment. For example, a configuration may be adopted in which both the seal lips 39, 40 protrude in the same direction. In addition, a configuration may also be adopted in which the cross-sectional shapes (sizes) of both the seal lips 39, 40 are substantially symmetrical with each other. According to this configuration, the two seal lips 39, 40 are brought into contact with the guide rail 11 with a more uniform force, thereby making it possible to stabilize the moving position of the door glass G further. In addition, the positions where both the seal lips 39, 40 are provided are not limited to those described in the embodiment, and the seal lips 39, 40 may be provided at any positions, provided that they are provided between the exterior seal lip 33 and the interior seal lip 36. For example, a configuration may be adopted in which the interior sub-seal lip 40 is provided on the first base portion 30.

(e) The configuration of the mount portion of the door 1 on which the glass run 2 is mounted is not limited to that described in the embodiment. For example, a configuration may be adopted in which the sash 20 is omitted, or a configuration may be adopted in which a mounted portion is integrally provided with the sash 20, the exterior member (retainer) 21 and the interior member 22, or a sash having, for example, a substantially U-shaped cross section is provided.

What is claimed is:

1. A glass run adapted to be mounted on a vehicle door to guide a door glass to which a guide member is attached in a vertical part of said door glass such that an edge portion of said guide member protrudes from an end face of said vertical part of said door glass, said glass run comprising:
a main body mountable on a mount portion of said vehicle door;
a first seal lip continuously formed with said main body so as to be brought into contact with an exterior side surface of said guide member;
a second seal lip continuously formed with said main body so as to be brought into contact with an interior side surface formed in said door glass or said guide member; and
a third seal lip and a fourth seal lip which are continuously formed with said main body between a position at which said first seal lip is formed and a position at which said second seal lip is formed, said third seal lip being brought into contact with said guide member at a position on an interior side of said first seal lip and said fourth seal lip being brought into contact with said guide member at a position on an interior side of said third seal lip.

2. A glass run according to claim 1, wherein
said main body includes:
a first base portion mountable on a first mount section of said vehicle door which is provided substantially in parallel with an interior side surface of said door glass,
a second base portion mountable on a second mount section of said vehicle door which extends from an one end portion of said first base portion so as to face an end face of said vertical part of said door glass and an end face of said edge portion of said guide member, and
a third base portion mountable on a third mount section of said vehicle door which extends from another end portion of said first base portion and which is provided in a vicinity of said first mount section;
said first seal lip extending from a distal end portion of said second base portion;
said second seal lip extending from a distal end portion of said third base portion;
said third seal lip extending from said second base portion; and
said fourth seal lip extending from said first base portion or said second base portion.

3. A glass run adapted to be mounted on a vehicle door including a door glass movable in a vertical direction; and a guide member provided along a vertical part of said door glass such that an edge portion thereof protrudes from an end face of said vertical part and having a projecting portion which is projected toward an interior side from a vicinity of said edge portion, said glass run comprising:
a main body including
a first base portion mountable on a first mount section of said vehicle door which is provided substantially in parallel with an interior side surface of said door glass,
a second base portion mountable on a second mount section of said vehicle door which extends from an one end portion of said first base portion so as to face an end face of said vertical part of said door glass and an end face of said edge portion of said guide member, and
a third base portion mountable on a third mount section of said vehicle door which extends from another end portion of said first base portion and which is provided in a vicinity of said first mount section;
a first seal lip extending from a distal end portion of said second base portion so as to be brought into contact with an exterior side surface of said guide member;
a second seal lip extending from a distal end portion of said third base portion so as to be brought into contact with an interior side surface of said guide member;
a third seal lip extending from said second base portion so as to be brought into contact with said guide member at a position on an interior side of said first seal lip; and
a fourth seal lip extending from said first base portion or said second base portion so as to be brought into contact with said guide member at a position on an interior side of said third seal lip.

4. A glass run according to claim 3, wherein said third base portion includes:
a restricting wall part which extends toward an exterior side from said another other end portion of said first base portion for restricting said projecting portion; and
a mount wall part which extends from a distal end portion of said restricting wall part so as to be mounted on said third mount section; and
wherein said second seal lip extends from a distal end portion of said mount wall part.

5. A glass run according to claim 3, wherein said guide member has a curved end face which defined from said edge portion of said guide member to an interior end portion of said projecting portion; and
wherein said third seal lip and said fourth seal lip are made to contact with said curved end face.

6. A glass run according to claim 2, wherein said guide member is provided such that said exterior side surface thereof becomes substantially in parallel with said interior side surface of said door glass and
said exterior side surface of said guide member is located flush or on an interior side with respect to said interior side surface of said door glass;
wherein said second base portion includes a facing wall part which extends from said end portion of said first base portion and which is provided so as to face said end face of said vertical part of said door glass and said end face of said edge portion of said guide member, and
an exterior wall part which extends from a distal end of said facing wall part toward said end face of said door glass and which is provided substantially in parallel with said exterior side surface of said guide member; and
wherein said first seal lip is made to extend from a distal end portion of said exterior wall part toward said facing wall part.

7. A glass run according to claim 1, wherein said third seal lip and said fourth seal lip are formed so as to protrude toward each other.

8. A vehicle door comprising:
a door glass;
a guide member attached on an interior side surface of said door glass in a vertical part of said door glass such that an edge portion of said guide member protrudes from an end face of said vertical part of said door glass and an exterior side surface of said guide member is located on an interior side with respect to an exterior side surface of said door glass,
a glass run to guide said door glass, including
a main body engaged with a mount portion,
a first seal lip continuously formed with said main body so as to be brought into contact with said exterior side surface of said guide member,
a second seal lip continuously formed with said main body so as to be brought into contact with one of the interior side surface formed in said door glass or said guide member, and
a third seal lip and a fourth seal lip which are continuously formed with said main body between a position at which said first seal lip is formed and a position at which said second seal lip is formed, said third seal lip being brought into contact with an end face of said guide member and said fourth seal lip being brought into contact with a curved face of said guide member formed on an interior side of said end face.

9. A vehicle door according to claim 8, said main body of said glass run includes an exterior wall part from which said first seal lip extends,
said exterior wall part is engaged with an interior side surface of an exterior member whose exterior surface is substantially flush with said exterior surface of said door glass.

10. A vehicle door according to claim 8, wherein said third seal lip and said fourth seal lip are formed so as to protrude toward each other.
